(19) United States
(12) Patent Application Publication
(10) Pub. No.: US 2024/0239340 A1
(43) Pub. Date: Jul. 18, 2024

(54) VEHICLE CONTROL APPARATUS

(71) Applicant: TOYOTA JIDOSHA KABUSHIKI KAISHA, Toyota-shi (JP)

(72) Inventor: Naoki KUSUMOTO, Okazaki-shi (KR)

(73) Assignee: TOYOTA JIDOSHA KABUSHIKI KAISHA, Toyota-shi (JP)

(21) Appl. No.: 18/400,190

(22) Filed: Dec. 29, 2023

(30) Foreign Application Priority Data
Jan. 13, 2023 (JP) 2023-003585

(51) Int. Cl. B60W 30/14; B60W 30/165; B60W 30/18; G06V 20/59

(52) U.S. Cl. CPC B60W 30/143; B60W 30/165; B60W 30/18154; G06V 20/597; B60W 2420/403; B60W 2540/225; B60W 2552/53

(57) ABSTRACT

A vehicle control apparatus includes a candidate vehicle detection unit configured to detect a control target candidate vehicle which is a vehicle within a preset detection area of the external sensor and a viewing direction recognition unit configured to recognize a viewing direction of a driver of the host vehicle based on a captured image of a driver monitor camera of the host vehicle. The vehicle control apparatus includes a control target vehicle determination unit configured to determine a control target vehicle from among the plurality of control target candidate vehicles based on the viewing direction of the driver when there is the plurality of control target candidate vehicles.

### CROSS-REFERENCE TO RELATED APPLICATIONS

This application is based upon and claims the benefit of priority from Japanese Patent Application No. 2023-003585, filed on Jan. 13, 2023, the entire contents of which are incorporated herein by reference.

### BACKGROUND

### Field

The present disclosure relates to a vehicle control apparatus.

### DESCRIPTION OF THE RELATED ART

Japanese Patent No. 6825081 has been known as a technical document related to a vehicle control apparatus. In this publication, a vehicle control apparatus is described. This is a device that performs follow-up control for following a preceding vehicle. When the host vehicle reaches an intersection at which the host vehicle turns right or left, the device releases the following control.

### SUMMARY

However, even at an intersection or a branch point, it is required to appropriately perform follow-up control for a preceding vehicle. However, a problem arises in a situation in which other vehicles are present in each of a plurality of lanes at branch destinations. A preceding vehicle (control target vehicle) to be followed cannot be determined until the course of the host vehicle is determined. For this reason, erroneous follow-up control may be performed.

An aspect of the present disclosure is a vehicle control apparatus for performing vehicle speed control of a host vehicle based on a detection result of a control target vehicle in front of the host vehicle, detected by an external sensor of the host vehicle. The vehicle control apparatus includes a candidate vehicle detection unit configured to detect a control target candidate vehicle which is a vehicle within a preset detection area of the external sensor, a viewing direction recognition unit configured to recognize a viewing direction of a driver of the host vehicle based on a captured image of a driver monitor camera of the host vehicle, and a control target vehicle determination unit configured to determine a control target vehicle from among the plurality of control target candidate vehicles based on the viewing direction of the driver when there is the plurality of control target candidate vehicles.

The vehicle control apparatus according to an aspect of the present disclosure may further include a determination unit configured to determine whether there is a branch point or an intersection in front of the host vehicle. The candidate vehicle detection unit may detect the control target candidate vehicle within the detection area of the external sensor when there is a branch point or an intersection in front of the host vehicle.

According to an aspect of the present disclosure, when there is a plurality of control target candidate vehicles, the control target vehicle of the vehicle speed control of the host vehicle can be determined earlier.

### BRIEF DESCRIPTION OF THE DRAWINGS

FIG. 1 is a block diagram illustrating a vehicle control apparatus according to an exemplary embodiment.

FIG. 2 is a plan view illustrating a situation in which a plurality of control target candidate vehicles exists.

FIG. 3 is a flowchart illustrating an example of control target vehicle recognition processing.

### DETAILED DESCRIPTION

Hereinafter, embodiments of the present disclosure will be described with reference to the drawings.

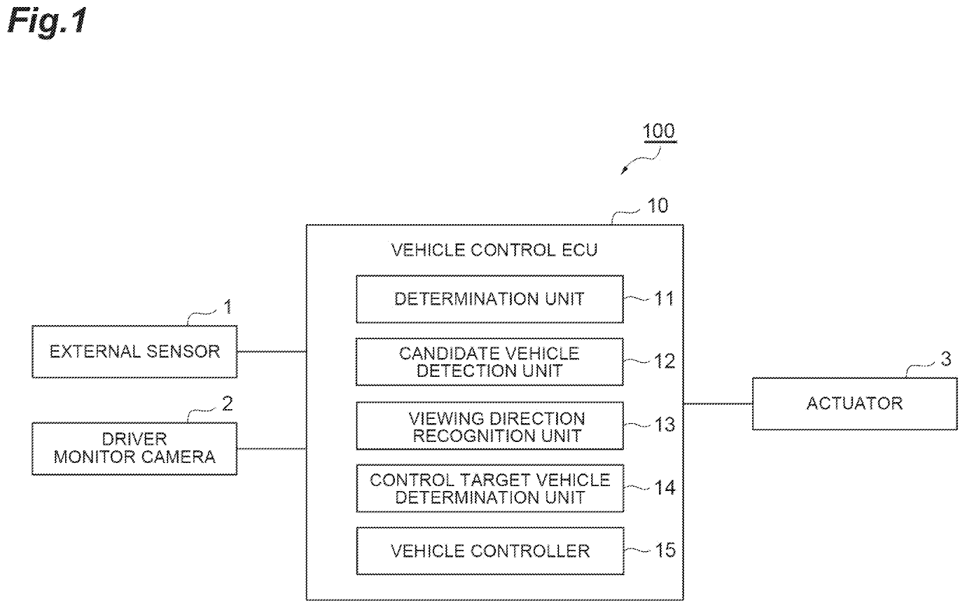

As illustrated in FIG. 1, a vehicle control apparatus 100 according to the present embodiment is a device that is mounted on a host vehicle and performs vehicle speed control of the host vehicle. The host vehicle may be a passenger vehicle or a cargo vehicle. The host vehicle is a vehicle that can be manually driven by a driver.

Vehicle speed control is control of the vehicle speed of the host vehicle according to the relative situation between the control target vehicle, which is the other vehicle in front of the host vehicle, and the host vehicle. The relative situation includes a distance and a relative vehicle speed. The vehicle speed control includes at least one of cruise control, adaptive cruise control, and deceleration control.

### Configuration of Vehicle Control Apparatus

As illustrated in FIG. 1, the vehicle control apparatus 100 includes a vehicle-control electronic control unit (ECU) 10 that integrally manages the device. A vehicle control ECU10 includes a central processing unit (CPU), a read-only memory (ROM), a random-access memory (RAM), and a controller area network (CAN). The electronic control unit has a communication circuit or the like. In the vehicle control ECU10, for example, a program stored in the ROM is loaded into the RAM, and the program loaded into the RAM is executed by the CPU to implement various functions. The vehicle control ECU10 may be composed of a plurality of electronic units.

The vehicle control ECU10 is connected to an external sensor 1, a driver monitor camera 2, and an actuator 3. The external sensor 1 is a detection device that detects a situation around the host vehicle. The external sensor 1 may include at least one of a camera and a radar sensor.

The camera is an imaging device that images an external situation of the host vehicle. The camera is provided on the back side of the windshield of the host vehicle, for example, and captures an image in front of the host vehicle. The camera transmits a captured image related to an external situation of the host vehicle to the vehicle control ECU10. The camera may be a monocular camera or a stereo camera as long as the relative situation between the control target vehicle in front of the host vehicle and the host vehicle can be detected.

The radar sensor is a detection device that detects an object around the host vehicle using radio waves (for example, millimeter waves) or light. The radar sensor includes, for example, a millimeter wave radar or a light detection and ranging (LIDAR). The radar sensor detects an object such as another vehicle by transmitting radio waves or light to the surroundings of the host vehicle and receiving radio waves or light reflected by the object. The radar sensor transmits information on the detected object to the vehicle control ECU10.

The driver monitor camera 2 is an imaging device that images the driver of the host vehicle. The driver monitor camera 2 is provided on a cover of a steering column of the host vehicle, for example, and images at least the face of the driver. A plurality of the driver monitor camera 2 may be provided in order to image the driver from a plurality of directions. The driver monitor camera 2 transmits the captured image of the driver to the vehicle control ECU10.

The actuator 3 is a device used to control the host vehicle. The actuator 3 includes at least a drive actuator, a brake actuator, and a steering actuator. The drive actuator controls the amount of air supplied to the engine (throttle opening) in accordance with a control signal from the vehicle control ECU10, and controls the driving force of the host vehicle. When the host vehicle is a hybrid electric vehicle (HEV), a control signal from the vehicle control ECU10 is input to a motor as a power source in addition to the amount of air supplied to the engine, and the driving force is controlled. When the host vehicle is a battery electric vehicle (BEV), a control signal from the vehicle control ECU10 is input to a motor as a power source, and the driving force is controlled. The motor in such cases as a power source, constitutes the actuator 3.

The brake actuator controls a brake system in response to a control signal from the vehicle control ECU10, and controls a braking force applied to wheels of the host vehicle. As the brake system, for example, a hydraulic brake system can be used. The steering actuator controls driving of an assist motor for controlling steering torque in an electric power steering system according to a control signal from the vehicle control ECU10. Accordingly, the steering actuator controls the steering torque of the host vehicle.

Next, the functional configuration of the vehicle control ECU10 will be described. The vehicle control ECU10 has a determination unit 11, a candidate vehicle detection unit 12, a viewing direction recognition unit 13, a control target vehicle determination unit 14, and a vehicle controller 15.

The determination unit 11 determines whether there is a branch point or an intersection in front of the host vehicle. This determination is performed when the distance between the branch point or the intersection and the host vehicle is less than the determination threshold value. The determination threshold is a value set in advance, and this value is not particularly limited. For example, the determination threshold value can be any of 20m, 10m, 5m, and 3m.

The determination unit 11 determines whether there is a branch point or an intersection in front of the host vehicle based on, for example, the position information of the host vehicle on the map and the map information. The position information of the host vehicle on the map is acquired by a signal from a positioning satellite of a global navigation satellite system (GNSS), for example. The determination unit 11 may recognize a branch point or an intersection by inter-vehicle communication from the other vehicle traveling ahead on the same road as the host vehicle. The determination unit 11 may recognize a branch point or an intersection through pattern matching based on a detection result of the external sensor of the host vehicle.

When a branch point or an intersection exists in front of the host vehicle, the candidate vehicle detection unit 12 detects the control target candidate vehicle in the detection area of the external sensor 1. The candidate vehicle detection unit 12 recognizes a branch point in front of the host vehicle or a plurality of lanes ahead of the branch point, and detects a control target candidate vehicle based on a recognition result of the lane. The control target candidate vehicle is a vehicle that is a candidate for the control target vehicle in the vehicle speed control of the host vehicle.

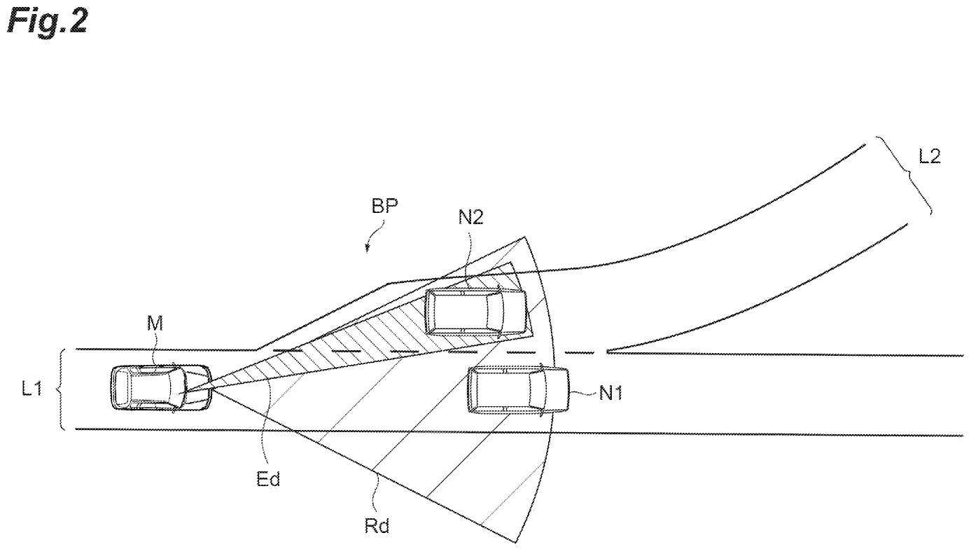

FIG. 2 shows the area in front of the host vehicle M, which is operating with cruise control activated. FIG. 2 illustrates a branch point BP, a host vehicle M, the host vehicle M, a branch path L2 branching from the lane L1, other vehicle (control target candidate vehicle) N1, and other vehicle (control target candidate vehicle) N2. The other vehicle N1 is running on the lane L1. The other vehicle N2 is running on the branch path L2. FIG. 2 illustrates A detection area Rd of the external sensor 1 and a viewing area ED of the driver.

FIG. 2 is a plan view illustrating a situation in which a plurality of control target candidate vehicles exists. In this situation, there are another vehicle N1 and another vehicle N2 in the detection area Rd of the external sensor 1. The course of the host vehicle M has not yet been determined. In such a situation, the candidate vehicle detection unit 12 recognizes the lane L1 and the branch path L2 beyond the branch point BP in front of the host vehicle M.

The candidate vehicle detection unit 12 recognizes the lane L1 and the branch path L2 based on map information or a detection result of the external sensor 1. The candidate vehicle detection unit 12 detects a control target candidate vehicle N1 and N2 in the detection area Rd of the external sensor 1 based on the position information of the other vehicle N1 and N2 detected by the external sensor 1 and lane information related to the lane L1 and the branch path L2. The candidate vehicle detection unit 12 does not detect other vehicles at positions away from the lane L1 and the branch path L2 as control target candidate vehicles even if other vehicles are present in the detection area Rd of the external sensor 1. The other vehicles at positions away from the lane L1 and the branch path L2 also include other vehicles stopped on the shoulders.

The viewing direction recognition unit 13 recognizes the viewing direction of the driver of the host vehicle based on the captured image of the driver monitor camera 2 of the host vehicle. The viewing direction recognition unit 13 detects the face direction or the line-of-sight direction of the driver from the face image of the driver. The viewing direction recognition unit 13 recognizes the viewing direction of the driver from the face direction or the line-of-sight direction. The viewing direction of the driver may be the direction of the face direction itself or the direction of the line of sight itself. The viewing direction of the driver may be obtained by combining the face direction and the line-of-sight direction of the driver.

The viewing direction recognition unit 13 may determine the viewing area ED from the viewing direction as illustrated in FIG. 2. The viewing area ED may be, for example, a fan-shaped area having a predetermined angle range around the viewing direction in a plan view. The angle range may be a fixed value, or may be calculated from the face direction angle or the sight line angle of the driver.

When there is a plurality of control target candidate vehicles, the control target vehicle determination unit 14 specifies the control target vehicle from among the plurality of control target candidate vehicles based on the viewing direction of the driver. In the situation illustrated in FIG. 2, the control target vehicle determination unit 14 specifies the control target candidate vehicle N2, which is included in the viewing area ED of the driver, from among the control target candidate vehicles N1 and N2 in the detection area Rd of the external sensor 1, as the control target vehicle for the cruise control of the host vehicle M.

The vehicle controller 15 executes vehicle speed control such as cruise control based on the relative situation between the control target vehicle and the host vehicle determined by the control target vehicle determination unit 14. The vehicle controller 15 performs vehicle speed control of the host vehicle by transmitting a control signal to the actuator 3.

### Control Target Vehicle Recognition Processing of Vehicle Control Apparatus

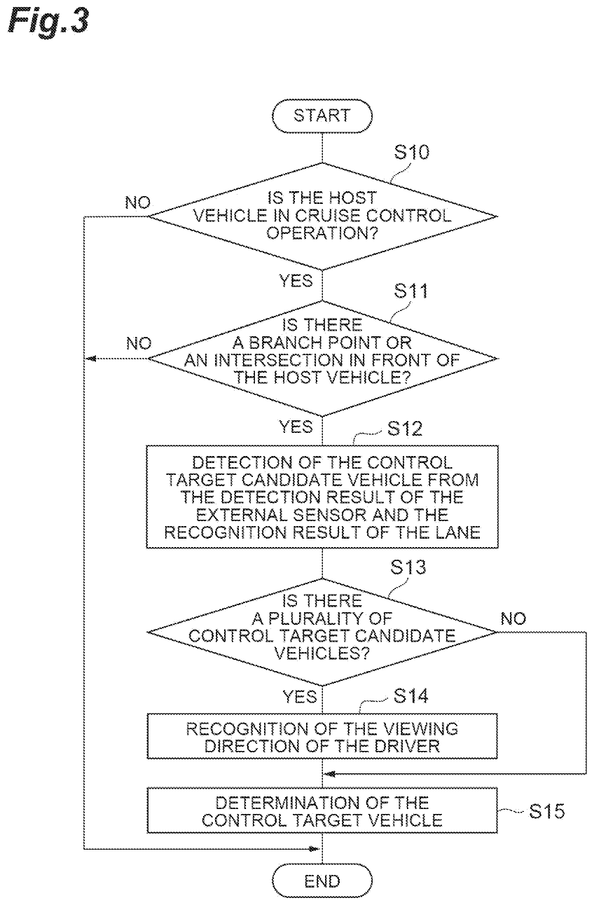

Next, control target vehicle recognition processing in the vehicle control apparatus 100 of the present embodiment will be described with reference to FIG. 3. FIG. 3 is a flowchart illustrating an example of control target vehicle recognition processing. The control target vehicle recognition processing is executed while the host vehicle is traveling, for example.

As illustrated in FIG. 3, the vehicle control ECU10 of the vehicle control apparatus 100 determines whether the host vehicle is in cruise control operation as S10. If the vehicle control ECU10 determines that the host vehicle is in cruise control operation, the host vehicle transitions to S11. When the vehicle control ECU10 does not determine that the host vehicle is in the cruise control operation, the control target vehicle recognition processing of this time is ended.

In S11, the vehicle control ECU10 determines whether there is a branch point or an intersection in front of the host vehicle by the determination unit 11. When it is determined that there is a branch point or an intersection in front of the host vehicle, the vehicle control ECU10 transitions to S12. If the vehicle control ECU10 does not determine that there is a branch point or an intersection in front of the host vehicle, the control target vehicle recognition processing ends. In this case, the vehicle control ECU10 performs the cruise control on the preceding vehicle of the host vehicle in a normal manner.

In S12, the vehicle control ECU10 detects the control target candidate vehicle by the candidate vehicle detection unit 12. The candidate vehicle detection unit 12 detects a control target candidate vehicle in the detection area of the external sensor 1. Also, the candidate vehicle detection unit 12 recognizes a branch point in front of the host vehicle or a plurality of lanes ahead of the branch point, and detects a control target candidate vehicle based on a recognition result of the lane.

In S13, the vehicle control ECU10 determines whether there is a plurality of control target candidate vehicles. If the vehicle control ECU10 determines that there is a plurality of control target candidate vehicles, the vehicle control ECU10 transitions to S14. If the vehicle control ECU10 does not determine that there are multiple control target candidate vehicles, the vehicle control ECU10 transitions to

S15.

In S14, the vehicle control ECU10 recognizes the viewing direction of the driver by the viewing direction recognition unit 13. The viewing direction recognition unit 13 recognizes the viewing direction of the driver by detecting the face direction or the line-of-sight direction of the driver from the face image of the driver. The vehicle control ECU10 then transitions to the S15.

In S15, the vehicle control ECU10 performs the determination of the control target vehicle by the control target vehicle determination unit 14. When there is only one control target candidate vehicle, the control target vehicle determination unit 14 determines the control target candidate vehicle as a control target vehicle. When there is a plurality of control target candidate vehicles, the control target vehicle determination unit 14 determines the control target vehicle from among the plurality of control target candidate vehicles based on the viewing direction of the driver. As shown in the FIG. 2, for example, the control target vehicle determination unit 14 determines the control target candidate vehicle N2 included in the viewing area ED of the driver among the control target candidate vehicle N1 and N2 in the detection area Rd in the external sensor 1 as a control target vehicle of the cruise control of the host vehicle M. Thereafter, the vehicle control ECU10 ends the control target vehicle recognition processing.

According to the vehicle control apparatus 100 according to the present embodiment described above, when a plurality of control target candidate vehicles is detected in the detection area Rd of the external sensor 1, the control target vehicle is determined based on the viewing direction of the driver of the host vehicle. Thus, the control target vehicle can be determined earlier than in the conventional case where the travel direction of the host vehicle is determined at an intersection or branch point and then the control target vehicle is determined. As a result, in the vehicle control apparatus 100, it is possible to perform control intervention of vehicle speed control such as deceleration at an earlier timing than in the related art, and thus it is possible to suppress occurrence of excessive approach of the host vehicle to the other vehicle in front of the host vehicle or sudden deceleration of the host vehicle.

Further, in the vehicle control apparatus 100, since the control target vehicle is determined when there is a branch point or an intersection in front of the host vehicle, it is possible to avoid performing unnecessary processing even if the other vehicle of the adjacent lane is included in the detection area Rd of the external sensor 1 while traveling on a road having a plurality of lanes. Furthermore, in the vehicle control apparatus 100, by considering the recognition result of the lane ahead of the branch point or the intersection, it is possible to appropriately detect the control target candidate vehicle by excluding the other vehicle outside the lane.

Although embodiments of the present disclosure have been described above, the present disclosure is not limited to the above-described embodiments. The present disclosure can be implemented in various forms in which various changes and modifications are made based on the knowledge of those skilled in the art, including the above-described embodiments.

The vehicle control apparatus 100 does not necessarily need the determination unit 11. Even when there is no branch point or intersection in front of the host vehicle, the vehicle control apparatus 100 may determine the control target vehicle when a plurality of control target candidate vehicles is detected.

The candidate vehicle detection unit 12 does not necessarily need to use lane information to detect the control target candidate vehicle. In this case, the candidate vehicle detection unit 12 does not need to recognize the branch path or the lane ahead of the intersection.

The control target vehicle determination unit 14 does not necessarily need to use the viewing area ED of the driver. The control target vehicle determination unit 14 may identify a control target candidate vehicle closest to the viewing direction of the driver among the plurality of control target candidate vehicles as the control target vehicle of the vehicle speed control of the host vehicle.

What is claimed is:

1. A vehicle control apparatus for performing vehicle speed control of a host vehicle based on a detection result of a control target vehicle in front of the host vehicle, detected by an external sensor of the host vehicle, the vehicle control apparatus comprising:
a candidate vehicle detection unit configured to detect a control target candidate vehicle which is a vehicle within a preset detection area of the external sensor;
a viewing direction recognition unit configured to recognize a viewing direction of a driver of the host vehicle based on a captured image of a driver monitor camera of the host vehicle; and
a control target vehicle determination unit configured to determine a control target vehicle from among the plurality of control target candidate vehicles based on the viewing direction of the driver when there is the plurality of control target candidate vehicles.

2. The vehicle control apparatus according to claim 1, further comprising:
a determination unit configured to determine whether there is a branch point or an intersection in front of the host vehicle, and
wherein the candidate vehicle detection unit detects the control target candidate vehicle within the detection area of the external sensor when there is the branch point or the intersection in front of the host vehicle.

3. The vehicle control apparatus of claim 1, further comprising:
a determination unit configured to determine whether there is a branch point or an intersection in front of the host vehicle, and
wherein the candidate vehicle detection unit recognizes a plurality of lanes ahead of a branch point or an intersection when there is the branch point or the intersection in front of the host vehicle, and detects the control target candidate vehicle based on a recognition result of the lanes.

4. The vehicle control apparatus of claim 2, wherein the candidate vehicle detection unit recognizes a plurality of lanes ahead of the branch point or the intersection when there is the branch point or the intersection in front of the host vehicle, and detects the control target candidate vehicle based on a recognition result of the lanes.
